(19) United States
(12) Patent Application Publication
(10) Pub. No.: US 2023/0079076 A1
(43) Pub. Date: Mar. 16, 2023

(54) WASTE RECOVERING SYSTEM AND METHOD THEREOF

(71) Applicant: RIGORTECH SDN. BHD., Petaling Jaya (MY)

(72) Inventors: Chze Loong Tan, Petaling Jaya (MY); Songpol BOONSAWAT, Petaling Jaya (MY)

(73) Assignee: RIGORTECH SDN. BHD., Petaling Jaya (MY)

(21) Appl. No.: 17/944,769

(22) Filed: Sep. 14, 2022

(30) Foreign Application Priority Data
Sep. 14, 2021 (MY) PI2021005373

(51) Int. Cl. C10G 1/10; C10B 53/07; C10B 33/02; C10G 1/00; C10G 5/06

(52) U.S. Cl. CPC C10G 1/10; C10B 53/07; C10B 33/02; C10G 1/002; C10G 5/06; C10G 2300/1003; C10G 2300/1007; C10G 2400/06; C10G 2400/04; C10G 2400/30

(57) ABSTRACT

The present invention relates to automated waste recovering system and method which is not limited to a specific type of waste only. The system comprises a reactor for pyrolysis, a condensing unit connected to a water-cooled chiller to obtain liquid phase products and non-condensable gas, a gas treatment unit, a series of gas filtration unit to obtain clean gas, a storage and a control unit. The system also comprises a gas mixer unit to mix the non-condensable gas with hydrogen to obtain hydrocarbon rich gas, an artificial fuel condensing unit for condensing the hydrocarbon rich gas to obtain artificial fuel and water, which subsequently separated in a phase separator unit. The present invention provides a means to achieve constant yield by controlling conditions in the reactor and further increase the yield by producing artificial fuel.

### TECHNICAL FIELD

The present invention relates to a system and a method for waste recovery. More particularly, the present invention relates to a system and a method of converting waste including organic and inorganic waste such as plastic waste to fuel and energy.

### BACKGROUND ART

Billion tonnes of waste are generated globally every year. While some waste can be recycled easily, other waste especially non-biodegradable waste such as plastic is much more difficult to recycle. Plastic waste poses a hazard to the wildlife, where thousands of wildlife died from ingesting or entangled in plastic waste. Plastic waste management includes incineration and disposal in landfill. However, plastic waste generally takes hundreds of years to fully decompose. Furthermore, toxic substances are released into soil during decomposition and also into the air during incineration. Apart from that, improper management of other waste such as oil waste may also leads to water contamination, which detrimental to wildlife, livestock and human health.

Hence, considering the huge amount of waste generated, it is more valuable to exploit waste's potential for recovery or production of value-added products and fuel rather than simply incinerating or disposing the waste. There have been a number of solutions that provide system or method of waste recovery and few of them are discussed below:

U.S. Pat. No. 10,538,708B2 discloses recycling and recovering method and system, namely organic compound disposal method and system for all types of plastic waste to generate more valuable usable fuel products such as flammable hydrocarbon gas and liquid fuels. The system comprises a reactor to receive the plastic waste, a burner to heat the plastic waste within the reactor to generate usable fuel products in gas form, a condensing unit to convert the usable fuel products into liquid phase products, a filtration system to filter the usable fuel products, a liquid spray system to neutralize acid gas emitted from reaction inside the reactor, an exhaust pipe to discharge the neutralized acid gas from the reactor which consequently reduce pressure inside the reactor, and a return flammable gas line connecting the filtration system with the burner configured to deliver back some of the remaining flammable gas to the burner. However, the system is not automated and limited to waste recycling and recovery of plastic waste only.

WO2020225219A1 discloses a method and a device waste recovery to obtain usable oils and waxes. The device is designed as a transportable container. The device mainly comprises a control unit for automated operation, a stuffing screw for continuous and automated feeding of input material, a pyrolysis reactor, a residual material discharge for discharging residual materials from the pyrolysis reactor, a staged condensation unit, and a cooling system. Apart from that, the method disclosed in this prior art includes the steps of pyrolyzing shredded waste material, condensing the condensable pyrolysis vapors using the staged condensation, cooling and separating solid residues, and processing to obtain non-condensable pyrolysis gases. Optionally, the condensable pyrolysis vapors can be filtered and discharged as product oils. However, this prior art is limited to waste recovery of plastic waste or residues containing polyolefin only.

WO2020104472A1 discloses a method and a device for cleaning contaminated used oil such as waste oil, contaminated diesel, heating oil, or shipping oils. The method includes the steps of indirectly feeding a starting material comprising the contaminated used oil to a molten bath, heating the starting material up to gas phase for evaporation, rectifying the resulting vapor in a rectification column, and removing purified oil as condensate from the rectification column. On the other hand, the device is designed to have a compact system configuration having a container structure. The device comprises a main reactor designed as the molten bath evaporator and the rectification column connected to the main reactor. This prior art allows the contaminated oily restudies to be usable again within a short period of time. However, this prior art is limited to liquid oily residues only.

Accordingly, it can be seen in the prior arts that there exists a need for an improved system and method for waste recovery that is not limited to a specific type of waste only. None of the above prior arts disclose a means to further increase the yield from waste recovery. Hence, there is a need for a system and method that can increase the yield obtained from waste recovery in order to fully exploit the waste's potential. Further, there exists a need for an automated system to increase efficiency in waste recovery.

### SUMMARY OF THE INVENTION

An objective of the present invention is to provide an automated waste recovering system having fully controllable and monitorable energy input, and providing high quality output, namely yield from converting waste to fuel.

Another objective of the present invention is to provide a waste recovering system that is suitable for different types of waste.

In addition, an objective of the present invention is to obtain constant yield of fuel and energy as well as providing a means to increase the yield by producing artificial fuel.

A further objective of the present invention is to provide a system and method of waste recovery that produce low emission by energy recycle.

Accordingly, the present invention relates to a waste recovering system. The system comprising a reactor to receive feed of an input material, and to pyrolyze the input material to obtain hot flammable gas; a water-cooled chiller; a condensing unit configured to receive and cool the hot flammable gas from the reactor by water recirculation between the condensing unit and the water-cooled chiller to obtain liquid phase products and non-condensable gas; a gas treatment unit connected to the condensing unit to treat the non-condensable gas, whereby a portion of the treated non-condensable gas passing through a series of filtration unit to obtain clean gas; a storage to store the liquid phase products; and a control unit to control parameters, internal and external conditions of the reactor; characterized in that, a gas mixer unit configured to receive another portion of the treated non-condensable gas, and mix with hydrogen to obtain hydrocarbon rich gas; an artificial fuel condensing unit connected to the gas mixer unit to condense the hydrocarbon rich gas to obtain artificial fuel and water; a phase separator unit to separate the artificial fuel and the water; wherein the series of filtration unit is connected to a waste water treatment unit as a water recirculating unit; wherein the water from the phase separator unit is fed to the waste water treatment and the artificial fuel is stored in the storage; and wherein the clean gas is injected back into the reactor to generate heat energy.

In accordance with an embodiment of the present invention, the input material is waste selected from a group consisting of, but not limited to, waste plastic, waste cooking oil, waste tires, waste engine oil and waste organic.

In accordance with an embodiment of the present invention, the reactor is configured to perform the pyrolysis at a temperature in a range between 300 and 700° C. inside the reactor.

In accordance with an embodiment of the present invention, the reactor is connected to a screw conveyor to automatically and continuously remove an activated carbon resulted from the pyrolysis reaction in the reactor.

In accordance with an embodiment of the present invention, the liquid phase products including, but not limited to, liquid duel, fuel oil, diesel and benzene.

In accordance with an embodiment of the present invention, the hydrogen is produced from a hydrogen on demand processing unit by splitting water into hydrogen and oxygen.

In accordance with an embodiment of the present invention, odor from the liquid phase products and the artificial fuel is removed using methanol scrubbing and oxygen.

The present invention also relates to a waste recovering method. The method comprising the steps of: feeding an input material to a reactor; pyrolyzing the input material in the reactor to produce hot flammable gas and activated carbon; condensing the hot flammable gas in a condensing unit to obtain liquid phase products and non-condensable gas by recirculating water between the condensing unit and a water-cooled chiller; storing the liquid phase products in a storage; and treating the non-condensable gas in a gas treatment unit; characterized in that, filtering a portion of the treated non-condensable gas under a series of filtration unit connected to a waste water treatment unit to obtain clean gas; mixing another portion of the treated non-condensable gas with hydrogen in a gas mixer unit to obtain hydrocarbon rich gas; condensing the hydrocarbon rich gas in an artificial fuel condensing unit to obtain artificial fuel and water; separating the artificial fuel and water in a phase separator unit; storing the artificial fuel in the storage; wherein the pyrolysis is performed in the reactor at a temperature in a range between 300 and 700° C.; wherein water from the phase separator unit is fed into the waste water treatment unit; and wherein clean gas is injected into the reactor to generate heat energy.

In accordance with an embodiment of the present invention, the input material is waste selected from a group consisting of, but not limited to, waste plastic, waste cooking oil, waste tires, waste engine oil and waste organic.

In accordance with an embodiment of the present invention, the activated carbon is automatically removed from the reactor using screw conveyor.

In accordance with an embodiment of the present invention, the liquid phase products including, but not limited to, liquid duel, fuel oil, diesel and benzene.

In accordance with an embodiment of the present invention, the hydrogen is produced from a hydrogen on demand processing unit by splitting water into hydrogen and oxygen.

In accordance with an embodiment of the present invention, pressure inside the reactor before release of the hot flammable gas is in a range between 100 and 500 psi.

The foregoing and other objects, features, aspects and advantages of the present invention will become better understood from a careful reading of a detailed description provided herein below with appropriate reference to the accompanying drawings.

### BRIEF DESCRIPTION OF THE ACCOMPANYING DRAWINGS

So that the manner in which the above recited features of the present invention can be understood in detail, a more particular description of the invention, briefly summarized above, may have been referred by embodiments, some of which are illustrated in the appended drawings. It is to be noted, however, that the appended drawing illustrates only typical embodiments of this invention and are therefore not to be considered limiting of its scope, for the invention may admit to other equally effective embodiments.

These and other features, benefits, and advantages of the present invention will become apparent by reference to the following text figure, with like reference numbers referring to like structures across the views, wherein:

FIG. 1 is a schematic representation of a waste recovering system in accordance with the preferred embodiments of the present invention.

FIG. 2 is a flowchart showing a waste recovering method implemented by the system in accordance with the preferred embodiments of the present invention.

### DETAILED DESCRIPTION OF THE PREFERRED EMBODIMENTS

While the present invention is described herein by way of example using embodiments and illustrative drawings, those skilled in the art will recognize that the invention is not limited to the embodiments of drawing or drawings described, and are not intended to represent the scale of the various components. Further, some components that may for a part of the invention may not be illustrated in certain figures, for ease of illustration, and such omissions do not limit the embodiments outlined in anyway. It should be understood that the drawings and detailed description thereto are not intended to limit the invention to the particular form disclosed, but on the contrary, the invention is to cover all modifications, equivalents, and alternatives falling within the scope of the present invention as defined by the appended claim. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Any discussion of documents, acts, materials, devices, articles and the like is included in the specification solely for the purpose of providing a context for the present invention. It is not suggested or represented that any or all of these matters form part of the prior art base or were common general knowledge in the field relevant to the present invention.

In this patent specification, whenever a composition or an element or a group of elements is preceded with the transitional phrase “comprising”, it is understood that we also contemplate the same composition, element or group of elements with transitional phrases “consisting of”, “consisting”, “selected from the group of consisting of, “including”, or “is” preceding the recitation of the composition, element or group of elements and vice versa.

The present invention is described hereinafter by various embodiments with reference to the accompanying drawing, wherein reference numerals used in the accompanying drawing correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only and are not intended to limit the scope of the claims. In addition, a number of materials are identified as suitable for various facets of the implementations. These materials are to be treated as exemplary and are not intended to limit the scope of the invention.

The present invention relates to automated waste recovering system (100) and method (340) which is not limited to a specific type of waste only. The system (100) comprises a reactor (120) for pyrolysis, a condensing unit (160) connected to a water-cooled chiller (140) to obtain liquid phase products and non-condensable gas, a gas treatment unit (200), a series of gas filtration unit (220) to obtain clean gas, a storage (180) and a control unit (320). The system (100) also comprises a gas mixer unit (260) to mix the non-condensable gas with hydrogen to obtain hydrocarbon rich gas, an artificial fuel condensing unit (280) for condensing the hydrocarbon rich gas to obtain artificial fuel and water, which subsequently separated in a phase separator unit (300). The present invention provides a means to achieve constant yield by controlling conditions in the reactor (120) and further increase yield by producing artificial fuel.

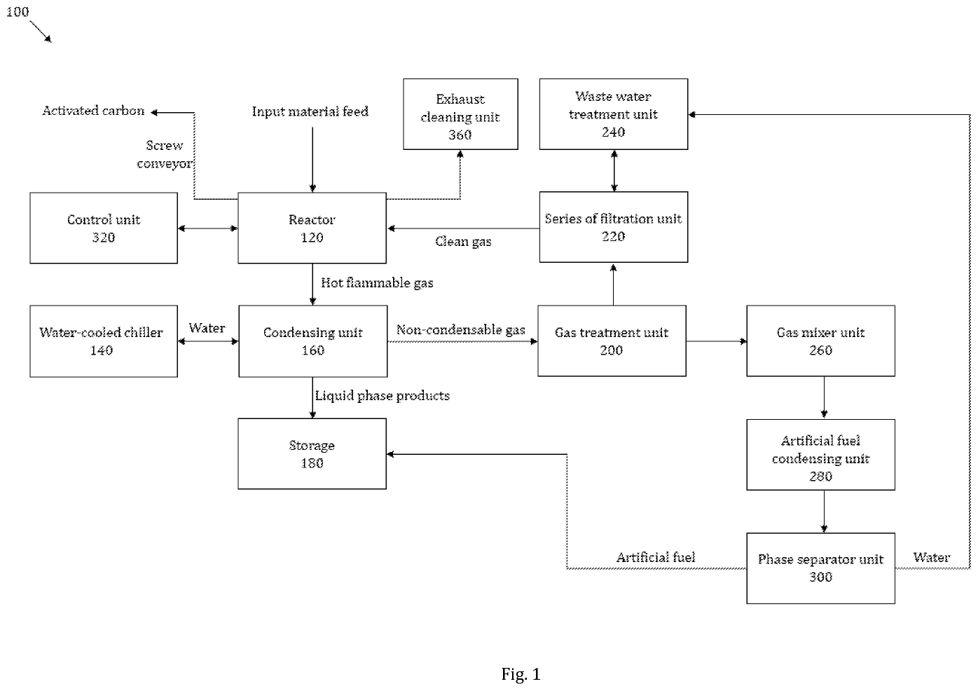

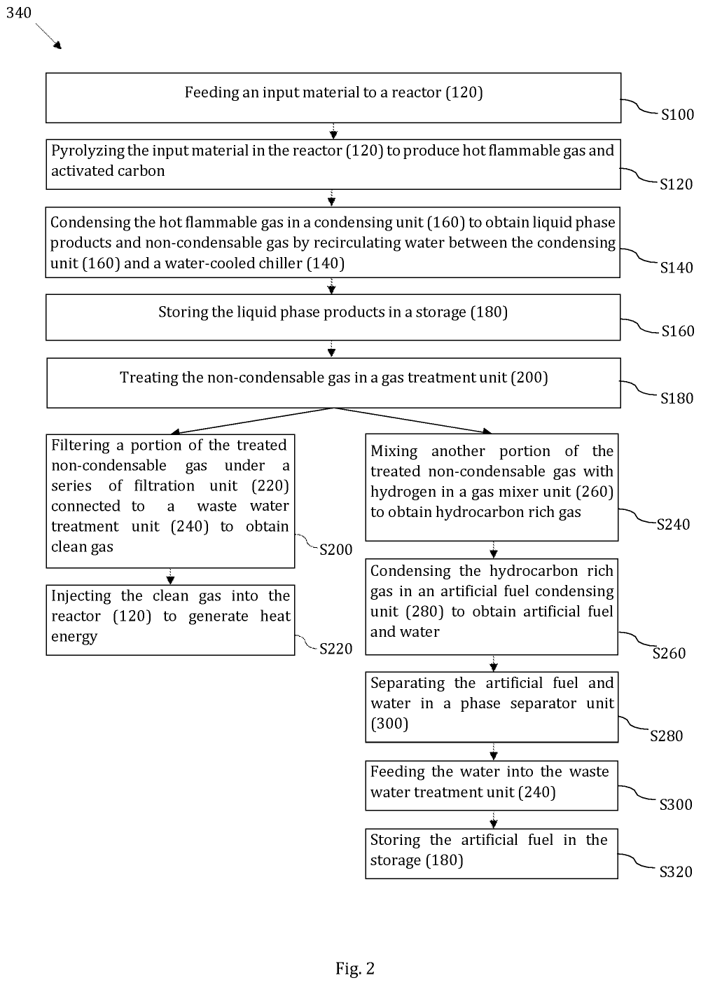

Referring to the drawings as shown in FIGS. 1 and 2, the invention will now be described in more detail.

FIG. 1 is a schematic representation of the waste recovering system (100) in accordance with the preferred embodiments of the present invention. The system (100) is a fully automated system with continuous process. The system (100) comprises the reactor (120) connected to the control unit (320), the water-cooled chiller (140), the condensing unit (160) connected to the reactor (120), the water-cooled chiller (140) and the storage (180). The system (100) also comprises the gas treatment unit (200) which connected to the condensing unit (160), the series of filtration unit (220) and the gas mixer unit (260). The series of filtration unit (220) is further connected with the waste water treatment unit (240) and also the reactor (120), while the gas mixer unit (260) is connected to the artificial fuel condensing unit (280), which in turn connected to the phase separator unit (300). In addition, the phase separator unit (300) is connected to the storage (180) and the waste water treatment unit (240).

More specifically, the reactor (120) is configured to receive the input material feed and heat the input material for pyrolysis recovery process, which produce activated carbon, hot flammable gas and acid gas. The input material is preferably organic or inorganic waste. Preferably, the reactor (120) is heated using heat input such as, but not limited to, liquefied petroleum gas (LPG), propane or natural gases. The hot flammable gas is released from the reactor (120) in percentages. Specifically, the pyrolysis is performed in the reactor (120) at a temperature in a range between 300 and 700° C. The temperature of pyrolysis is automatically adjusted according to the type of input material. More preferably, pyrolysis for hard plastic as input material is performed at a temperature in a range between 500 and 600° C. On the other hand, the temperature outside the reactor (120) is maintained in a range between 900 and 1200° C. Apart from that, the pressure inside the reactor (120) before hot flammable gas release is preferably in a range between 100 and 500 psi, while the pressure inside the reactor (120) after hot flammable gas release is more than 10 psi. The reactor (120) is also connected to an exhaust cleaning unit (360) to clean or neutralize the acid gas before emission to the environment, in which the release of neutralized acid gases also reduces the pressure inside the reactor (120).

The control unit (320) is configured to control parameters, internal and external conditions of the reactor (120). More preferably, the control unit is configured to send operation instructions to the system (100) based on readings of plurality of sensors installed on the reactor (120) and other units in the system (100). The plurality of sensors including, but not limited to, temperature, pressure, level and gas flow sensors. In addition, energy input of the reactor (120) is controlled by the control unit (320) based on, but not limited to, parameters, chemical reactions, internal and external conditions of the reactor (120), input material feed, heating algorithm, gas flow control as well as heat and flame from gases such as LPG, propane and natural gases. More particularly, the energy input is only injected into the reactor (120) and gas is only allowed to flow to achieve predetermined parameters. Gas flow is controlled by the control unit (320) using plurality of air control valves. More specifically, the gas flow rate is preferably 2 m/s. The control unit (320) is also configured with a notification application to conveniently notify a user on the system (100). The user is preferably not limited to a certified person for handling the system (100).

In accordance with an embodiment of the present invention, the input material is waste selected from a group consisting of, but not limited to, waste plastic, waste cooking oil, waste tires, waste engine oil and waste organic.

In accordance with an embodiment of the present invention, the reactor (120) is configured to perform the pyrolysis at a temperature in a range between 300 and 700° C. inside the reactor (120).

In accordance with an embodiment of the present invention, the reactor (120) is connected to the screw conveyor to automatically and continuously remove activated carbon resulted from pyrolysis reaction in the reactor (120).

As shown in FIG. 1, the system (100) applies water cooling method using the water-cooled chiller (140). Preferably, the water-cooled chiller (140) has a temperature in a range between 10 and 15° C. More particularly, the condensing unit (160) configured to receive the hot flammable gas from the reactor (120) and subsequently cool the hot flammable gas by water recirculation between the condensing unit (160) and the water-cooled chiller (140) to obtain constant yield of pyrolysis products, namely liquid phase products and non-condensable gas. The yield differs according to the type of input material. Preferably, the yield of pyrolysis products using plastic as input material is at least 80%. The storage (180) is configured to store the liquid phase products, while the gas treatment unit (200) connected to the condensing unit (160) is configured to receive the non-condensable gas for treatment.

In accordance with an embodiment of the present invention, the liquid phase products including, but not limited to, liquid duel, fuel oil, diesel and benzene.

In FIG. 1, the gas treatment unit (200) is connected to both of the series of filtration unit (220) and the gas mixer unit (260). More specifically, a portion of the treated non-condensable gas pass through the series of filtration unit (220) to obtain clean gas, while another portion of the treated non-condensable gas is mixed with hydrogen to obtain hydrocarbon rich gas in the gas mixer unit (260). The series of filtration unit (220) is connected to the waste water treatment unit (240), a water recycling approach that is used as a water recirculating unit. Preferably, the series of filtration unit (220) including gas filtration for, but not limited to, nitrogen oxides, sulfur oxides and carbon oxides. The clean gas is injected back into the reactor (120) to generate heat energy. On the other hand, the artificial fuel condensing unit (280) is configured to receive and condense the hydrocarbon rich gas to obtain artificial fuel and water, which are subsequently separated in the phase separator unit (300). Furthermore, water from the phase separator unit (300) is fed to the waste water treatment (240), while the artificial fuel is stored in the storage (180).

In accordance with an embodiment of the present invention, the hydrogen is preferably produced from a hydrogen on demand processing unit by splitting water into hydrogen and oxygen. Preferably, the water used is, but not limited to, distilled water.

In accordance with an embodiment of the present invention, the odor from the liquid phase products and the artificial fuel is removed using methanol scrubbing and oxygen.

FIG. 2 is a flowchart showing the waste recovering method (340) implemented by the system (100) in accordance with the preferred embodiments of the present invention. The method (340) is continuous and fully automated, which is controlled by the control unit (320) based on readings of the plurality of sensors installed on the reactor (120) and other units in the system (100). The plurality of sensors including, but not limited to, temperature, pressure, level and gas flow sensors. The method (340) begins with (S100) feeding the input material to the reactor (120), followed by (S120) pyrolyzing the input material in the reactor (120) to produce the hot flammable gas and the activated carbon byproduct. Preferably, heat input for the pyrolysis is obtained by using, but not limited to, LPG, propane or natural gases as fuel. Specifically, the pyrolysis is performed in the reactor (120) at a temperature in a range between 300 and 700° C. The temperature of pyrolysis is automatically adjusted according to the type of input material. More preferably, temperature of pyrolysis for hard plastic as input material is in a range between 500 and 600° C. On the other hand, the temperature outside the reactor (120) is maintained in a range between 900 and 1200° C.

In accordance with an embodiment of the present invention, pressure inside the reactor (120) before release of the hot flammable gas is in a range between 100 and 500 psi. Preferably, the pressure inside the reactor (120) after release of the hot flammable gas is more than 10 psi. Furthermore, acid gas produced from the pyrolysis reaction in the reactor (120) is cleaned or neutralized at the exhaust cleaning unit (360) connected to the reactor (120) before release to the environment, in which the release of neutralized acid gas reduces the pressure inside the reactor (120).

The method (340) continues with (S140) condensing the hot flammable gas in the condensing unit (160) to obtain constant yield of pyrolysis products, namely the liquid phase products and the non-condensable gas by recirculating water between the condensing unit (160) and the water-cooled chiller (140). The yield differs according to the type of input material. Preferably, the yield of pyrolysis products using plastic as input material is at least 80%. The method (340) is followed by the step of (S160) storing the liquid phase products in a storage (180); and (S180) treating the non-condensable gas in the gas treatment unit (200). Preferably, gas flow is controlled at 2 m/s using air control valves, in which gas is released or allow to flow when temperature and pressure in the system (100) reach a predetermined threshold. Furthermore, the water-cooled chiller (140) preferably has a temperature in a range between 10 and 15° C.

In accordance with an embodiment of the present invention, the input material is waste selected from a group consisting of, but not limited to, waste plastic, waste cooking oil, waste tires, waste engine oil and waste organic.

In accordance with an embodiment of the present invention, the activated carbon is automatically removed from the reactor (120) using screw conveyor.

In accordance with an embodiment of the present invention, the liquid phase products including, but not limited to, liquid duel, fuel oil, diesel and benzene.

As shown in FIG. 2, the method (340) continues with (S200) filtering a portion of the treated non-condensable gas under the series of filtration unit (220) connected to the waste water treatment unit (240) to obtain the clean gas; and (S240) mixing another portion of the treated non-condensable gas with hydrogen in the gas mixer unit (260) to obtain the hydrocarbon rich gas. Preferably, the series of filtration unit (220) including gas filtration for, but not limited to, nitrogen oxides, sulfur oxides and carbon oxides. The method (340) is followed by (S260) condensing the hydrocarbon rich gas in the artificial fuel condensing unit (280) to obtain the artificial fuel and water; (S280) separating the artificial fuel and water in the phase separator unit (300); and (S320) storing the artificial fuel in the storage (180). More specifically, artificial fuel is generated to increase yield from waste recovery, preferably up to 7%. On the other hand, water separated in the phase separator unit (300) is utilized by (S300) feeding the water into the waste water treatment unit (240). Furthermore, the obtained clean gas is injected (S220) into the reactor (120) to generate heat energy, which resulting to lower emission to the environment. Preferably, the artificial fuel odor is removed using methanol scrubbing and oxygen.

In accordance with an embodiment of the present invention, the hydrogen is produced from a hydrogen on demand processing unit by splitting water into hydrogen and oxygen. Preferably, the water used is, but not limited to, distilled water.

In conclusion, the present system (100) and method (340) offer the following advantageous effects compared to the currently existing methods:
1) fully automated, monitorable and controllable waste recovering system (100) which improves its overall efficiency;
2) provides a system (100) and method (340) that can be used for different types of waste;
3) ensures constant quality and constant yield from waste recovery by controlling optimum parameters and flow rate;
4) provide a means to further increase the yield up to 7% from the generation of artificial fuel;
5) lower cost of production due to lower fuel input, the use of waste water recycling, and the reinjection of clean gas into the reactor (120);
6) lower emission from the system (100) as clean gas is reinjected back into the reactor (120); and
7) system (100) that can be operated without requiring handling by a certified person.

The exemplary implementation described above is illustrated with specific shapes, dimensions, and other characteristics, but the scope of the invention also includes various other shapes, dimensions, and characteristics. Also, the components as described above could be manufactured in various other ways and could include various other materials.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the invention is anticipated to hold on to all other such alternatives, modifications, and variations that fall within the scope of the present invention and appended claims.

Although the present invention has been described with reference to specific embodiments, also shown in the appended figures, it will be apparent for those skilled in the art that many variations and modifications can be done within the scope of the invention as described in the specification and defined in the following claims.

Description of the reference numerals used in the accompanying drawings according to the present invention:

| Reference Numerals | Description |
|---|---|
| 100 | Waste recovering system |
| 120 | Reactor |
| 140 | Water-cooled chiller |
| 160 | Condensing unit |
| 180 | Storage |
| 200 | Gas treatment unit |
| 220 | Series of filtration unit |
| 240 | Waste water treatment unit |
| 260 | Gas mixer unit |
| 280 | Artificial fuel condensing unit |
| 300 | Phase separator unit |
| 320 | Control unit |
| 340 | Waste recovering method |
| 360 | Exhaust cleaning unit |

1. A waste recovering system, said system comprising:
a reactor to receive feed of an input material, and to pyrolyze said input material to obtain hot flammable gas;
a water-cooled chiller;
a condensing unit configured to receive and cool said hot flammable gas from said reactor by water recirculation between said condensing unit and said water-cooled chiller to obtain liquid phase products and non-condensable gas;
a gas treatment unit connected to said condensing unit to treat said non-condensable gas, whereby a portion of said treated non-condensable gas passing through a series of filtration unit to obtain clean gas;
a storage to store said liquid phase products; and
a control unit to control parameters, internal and external conditions of said reactor;
characterized in that,
a gas mixer unit configured to receive another portion of said treated non-condensable gas, and mix with hydrogen to obtain hydrocarbon rich gas;
an artificial fuel condensing unit connected to said gas mixer unit to condense said hydrocarbon rich gas to obtain artificial fuel and water;
a phase separator unit to separate said artificial fuel and said water;
wherein said series of filtration unit is connected to a waste water treatment unit as a water recirculating unit;
wherein said water from said phase separator unit is fed to said waste water treatment and said artificial fuel is stored in said storage; and
wherein said clean gas is injected back into said reactor to generate heat energy.

2. The system as claimed in claim 1, wherein said input material is waste selected from a group consisting of waste plastic, waste cooking oil, waste tires, waste engine oil and waste organic.

3. The system as claimed in claim 1, wherein said reactor is configured to perform said pyrolysis at a temperature in a range between 300 and 700° C. inside said reactor.

4. The system as claimed in claim 1, wherein said reactor is connected to a screw conveyor to automatically and continuously remove an activated carbon resulted from said pyrolysis reaction in said reactor.

5. The system as claimed in claim 1, wherein said liquid phase products including liquid duel, fuel oil, diesel and benzene.

6. The system as claimed in claim 1, wherein said hydrogen is produced from a hydrogen on demand processing unit by splitting water into hydrogen and oxygen.

7. The system as claimed in claim 1, wherein odor from said liquid phase products and said artificial fuel is removed using methanol scrubbing and oxygen.

8. A waste recovering method, said method comprising the steps of:
feeding an input material to a reactor;
pyrolyzing said input material in said reactor to produce hot flammable gas and activated carbon;
condensing said hot flammable gas in a condensing unit to obtain liquid phase products and non-condensable gas by recirculating water between said condensing unit and a water-cooled chiller;
storing said liquid phase products in a storage; and
treating said non-condensable gas in a gas treatment unit;
characterized in that,
filtering a portion of said treated non-condensable gas under a series of filtration unit connected to a waste water treatment unit (240) to obtain clean gas;
mixing another portion of said treated non-condensable gas with hydrogen in a gas mixer unit to obtain hydrocarbon rich gas;
condensing said hydrocarbon rich gas in an artificial fuel condensing unit to obtain artificial fuel and water;
separating said artificial fuel and water in a phase separator unit; storing said artificial fuel in said storage;
wherein said pyrolysis is performed in said reactor at a temperature in a range between 300 and 700° C.;
wherein water from said phase separator unit is fed into said waste water treatment unit; and
wherein said clean gas is injected into said reactor to generate heat energy.

9. The method as claimed in claim 8, wherein said input material is waste selected from a group consisting of waste plastic, waste cooking oil, waste tires, waste engine oil and waste organic.

10. The method as claimed in claim 8, wherein said activated carbon is automatically removed from said reactor using screw conveyor.

11. The method as claimed in claim 8, wherein said liquid phase products including liquid duel, fuel oil, diesel and benzene.

12. The method as claimed in claim 8, wherein said hydrogen is produced from a hydrogen on demand processing unit by splitting water into hydrogen and oxygen.

13. The method as claimed in claim 8, wherein pressure inside said reactor before release of said hot flammable gas is in a range between 100 and 500 psi.
